(19) United States
(12) Patent Application Publication
(10) Pub. No.: US 2006/0144640 A1
(43) Pub. Date: Jul. 6, 2006

(54) Method for producing a ring for a safety net, especially for rockfall or avalanche baffle works, and also a safety net

(76) Inventor: Stephan Beat Wartmann, Brugg (CH)

Correspondence Address: WENDEROTH, LIND & PONACK, L.L.P., 2033 K STREET N. W., SUITE 800, WASHINGTON, DC, 20006-1021, US

(21) Appl. No.: 11/268,507

(22) Filed: Nov. 8, 2005

(30) Foreign Application Priority Data
Nov. 26, 2004 (CH) 01952/04

(51) Int. Cl. A62B 1/22

(52) U.S. Cl. 182/138

(57) ABSTRACT

In a method for the production of a safety net consisting of intermeshing rings (1), a wire (2) is inserted in approximately its axial direction and shaped by bending into a ring (1) with several windings. While being fed through, the wire (2) is passed through two elements (3, 4) each provided with a through-opening (4′) and fully enclosed, and bent more or less into a ring (1) and, with each winding, is fed through these elements (3, 4), until the through-opening (4′) of these elements (3, 4) is more or less filled with wires (2). This ring (1) withstands loads better, while at the same time being simple to produce and the wire loops are additionally more consistently held together in a ring.

The invention concerns a method according to the generic terms of claim 1, safety net.

A safety net of the aforementioned type made of annular elements, for example for rockfall or avalanche baffle works, is disclosed in patent EP-B-0 679 457 and a method plus a device for producing such a safety net is described. The individual annular elements consist of a single wire which is formed into several loose windings, after which several C-shaped clamps are attached to hold the windings together at the perimeter of the ring and are thus deformed by means of closing members. There are at least three such clamps distributed over the perimeter of the ring. It can happen that when the safety net is under tensile load, for example when lumps of rock fall in, the net is loaded to the limit of extension, as the result of which the clamps spring off and the ring elements are no longer held together. It can, however, also happen that the corrosion protection of these clamps is inadequate due to distortion, the interfaces at the clamp ends or other influences.

The present invention is based on the problem of creating a method to manufacture a safety net by means of which the safety net is simple to produce and withstands loadings better and the wire loops are held together more consistently as a ring.

This problem is solved according to the invention by a method in accordance with the features of claim 1 and by a safety net in accordance with claim 5.

Further preferred embodiments of the inventive annular element form the subject matter of the dependent claims.

Due to the use of at least one element provided with a through-opening and fully enclosed for the radial cohesion of the windings, through which element the wire or strand is passed when being formed into the windings, not only is the manufacture of the ring simplified, but also a better cohesion of the windings is guaranteed under dynamic loads. There is also the fact that the individual windings are evenly loaded by the rings, and the total cross-section of the ring remains round. Surprisingly, it has been found that tensile strength dispersion of 25 to 40% is reduced to just a few percent as a result.

The invention will next be explained in more detail with the aid of the drawing, which shows:

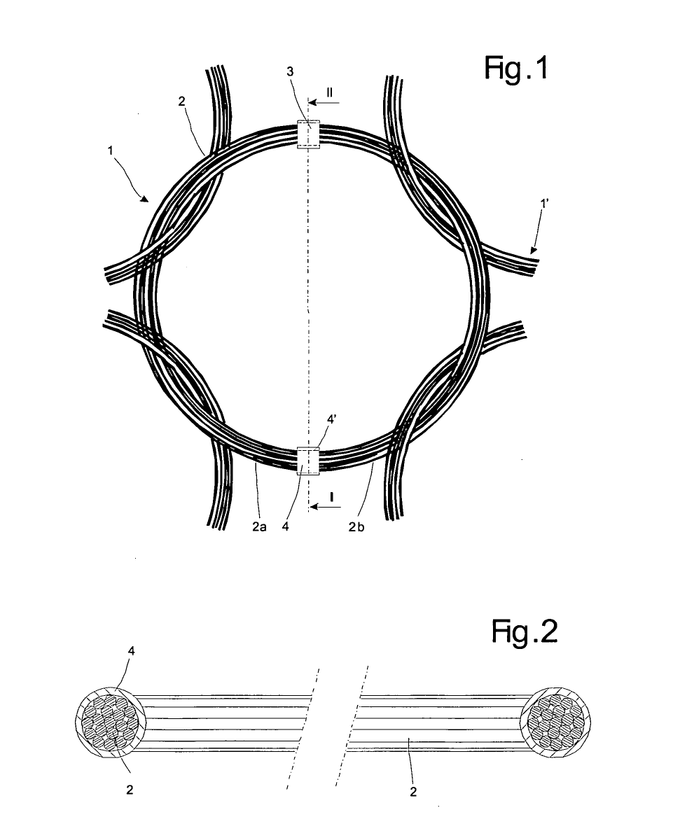

FIG. 1 a top view of an inventive ring as part of a safety net, which is wound around by four further rings,

FIG. 2 a section II-II of only the one ring from FIG. 1, and

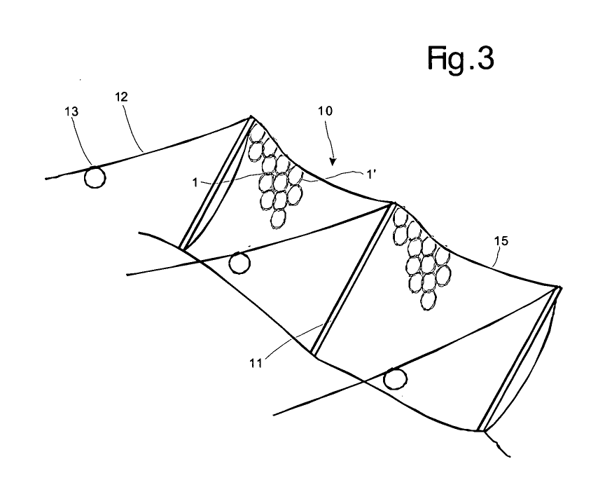

FIG. 3 a schematically represented safety net, which is composed of the intermeshing rings.

FIG. 1 shows a ring 1 for a safety net, especially for rockfall or avalanche baffle works, which is formed from a wire 2 shaped into several loose windings. The wire 2 consists of hot-galvanised or otherwise corrosion-protected rod stock or of stainless steel. The wire thickness is preferably 1 to 6 mm. The ring 1 usually encompasses between 3 and 20 windings. Instead of a wire, a strand of wound steel wires could also be used.

A bending device is used to shape the wire 2 into a ring of the desired diameter, as shown and described for example in EP-B-0 679 457. This patent specification also describes exhaustively how the safety net is produced from intermeshing annular elements, in that the windings of one annular element is threaded through at least one previously-produced annular element.

In order to hold the windings together, according to the invention the wire 2, as it is formed into the windings, is passed through two elements 3, 4, each provided with a through-opening 4′ and fully enclosed, and this is done until the respective through-opening 4′ of the element 3, 4 is more or less filled with wires 2.

Loose ends 2a, 2b of the wire 2 advantageously lie in an area adjacent to the two elements 3, 4 formed as rings, on both sides of this element 4. Obviously, more than two such elements could also be provided over the perimeter of the windings, although from experience just two elements 3, 4 are sufficient.

The elements 3, 4 preferably consist of aluminium or of a wrought aluminium alloy, of copper, of a wrought copper alloy or of steel or other metallic or synthetic type materials.

According to FIG. 2, these elements 3, 4 in the form of rings, at a pre-defined number of wire windings, advantageously have such an internal diameter that the wire coils fill the formed through-opening 4′ of the element, but in such a way that when the last wire loop is passed through, no jamming occurs. If necessary the elements 3, 4 can also be slightly compressed radially after the ring has been produced. It would also be possible to use an interlining in this element 3, 4 to fill up the through-opening 4′. This would then be an integral part of the element.

FIG. 3 shows a schematic view of a safety net 10, which is installed by way of example on a slope and which ensures that falling stones, timber or similar or snow avalanches are safely caught. This safety net 10, of which only a part of the inventive rings 1 are shown, is held via cables 15 by corresponding supports 11 anchored in the ground, which are in turn secured by retaining cables 12. The retaining cables 12 are preferably fitted with impact-absorbing braking elements 13 known in the art. It is foreseen that each ring 1 is wound around by four adjacent rings 1′.

The invention is sufficiently demonstrated by the existing embodiment. The number of wire threadings and also the dimensions of the rings can obviously be varied.

Equally, the element may be an oval or differently-shaped circular part encircling the wire loop package. It is also possible to use such an element only on one side of the ring or to use it on one side and a wire loop lashing or similar on the other side. In theory, too, more than one wire could be provided as a wire for the wire loops or strands.

1-10. (canceled)

11. Method for producing a ring for a safety net, especially for rockfall or avalanche baffle works, in which a wire or strand (2) is inserted in approximately its axial direction and is formed into a ring (1) with several windings by bending, wherein when being inserted, the wire or strand (2) is passed through at least one element (3, 4) which is provided with a through-opening (4′) and fully enclosed and more or less bent into a ring (1) and is passed through this element with each winding, until the through-opening (4′) of the element (3, 4) is approximately filled with wires or strands (2).

12. Method according to claim 11, wherein the wire or strand (2) is passed through two elements (3, 4) at a distance from each other, preferably situated opposite each other.

13. Method according to claim 11, wherein the wire or strand (2) is passed through at least one element (3, 4) and through several rings (1′) already produced, of the safety net (10) being produced.

14. Method according to claim 11, wherein at least one element (3, 4) is compressed after the wire (2) has been completely threaded through.

15. Safety net, especially for rockfall or avalanche baffle works, with intermeshing rings (1), which each have at least one wire or strand (2) which is or are formed into several loose windings, wherein at least one means is provided to hold together the windings radially, wherein the means is formed from an element (3, 4) provided with a through-opening (4′) and fully enclosed, through which the wire (2) or strand is passed with each winding.

16. Safety net according to claim 15, wherein loose ends (2a, 2b) of the wire or strand (2) in an area adjacent to the one element (3, 4) lie on both sides of this element (4).

17. Safety net according to claim 15, wherein the at least one element (3, 4) in the form of a ring or similarly shaped is made from aluminium or from a wrought aluminium alloy.

18. Safety net according to claim 15, wherein at least one element (3,4) is made from copper, from a wrought copper alloy or from another metallic or synthetic-type material.

19. Safety net according to claim 15, wherein at least one element (3, 4), at a pre-defined number of wire windings, has such an internal diameter that the wire coils approximately fill the formed internal space (4′) of the ring.

20. Safety net according to claim 15, wherein each ring (1) is wound around by several, preferably four, adjacent rings (1′).
